(19) United States
(12) Patent Application Publication
(10) Pub. No.: US 2021/0222013 A1
(43) Pub. Date: Jul. 22, 2021

(54) METHOD FOR ANTI-CORROSION TREATMENT OF A METAL SURFACE WITH REDUCED PICKLING MATERIAL

(71) Applicant: CHEMETALL GMBH, Frankfurt am Main (DE)

(72) Inventors: Michael Droege, Frankfurt am Main (DE); Anna Verena Mohr, Frankfurt am Main (DE); Daniel Schatz, Frankfurt am Main (DE); Marc Rittmeyer, Frankfurt am Main (DE)

(21) Appl. No.: 16/097,169

(22) PCT Filed: Apr. 28, 2017
(86) PCT No.: PCT/EP2017/060229

§ 371 Date: Oct. 26, 2018

(30) Foreign Application Priority Data
Apr. 29, 2016 (DE) 10 2016 207 431.8

(51) Int. Cl. C09D 5/12; C09D 133/10; C09D 163/00; C23F 11/173; C23C 22/73; C23C 22/34

(52) U.S. Cl. CPC C09D 5/12; C09D 133/10; C09D 163/00; C23C 2222/20; C23C 22/73; C23C 22/34; C23F 11/173

(57) ABSTRACT

A process for anticorrosion treatment of a metallic surface, including bringing the surface into successive contact with the an alkaline or acidic cleaner composition, a first rinsing composition, optionally a second rinsing composition, an acidic conversion composition, optionally a third rinsing composition, and a composition including a (meth)acrylate- and/or epoxide-based cathodic electrophoretic coating. At least one of the compositions includes at least one compound of the formula R¹O—(CH₂)ₓ—Z—(CH₂)_{y}—OR². R¹ and R² are each, independently of one another, H or an HO—(CH₂)_{w}— group with w≥2. X and y are each, independently of one another, from 1 to 4 and Z is an S atom or a C—C triple bond. An aqueous composition for reducing corrosive removal of material in anticorrosion treatment of metallic surfaces is disclosed.

The invention relates to a process for the anticorrosion treatment of a metallic surface and also to an aqueous composition for reducing the corrosive removal of material in the anticorrosion treatment of metallic surfaces.

In the anticorrosion treatment of metal strips and also of metallic components, as are used, for example, in vehicle construction, use is made of aqueous cleaning and conversion solutions which have a pH in the distinctly acidic or alkaline range.

In cleaning, the acidic or alkaline pH serves firstly to remove oxide films and also contamination from the metallic surface. In the subsequent acidic conversion treatment, the oxidative proton attack on the metallic surface itself results in the metal cations necessary for forming the conversion coating being dissolved from the metallic surface (known as anodic metal dissolution).

In other words: corrosive removal of material from the metallic surface occurs. Such a corrosive removal of material can take place not only in the conversion treatment but also as early as during cleaning, namely when the metallic surface itself is attacked after removal of oxide films and contamination.

There is then the problem that the metallic surface acquires a nonuniform morphology due to excessive corrosive removal of material, which is transferred to the deposited coatings, in particular conversion coatings, so that these also have a certain degree of nonuniformity. This in turn leads to a reduction in the strength of adhesion of subsequent coatings, in particular cathodic electrophoretic coatings, and associated therewith the corrosion protection.

It was therefore an object of the invention to avoid the disadvantages of the prior art and provide a process for the anticorrosion treatment of a metallic surface with reduced corrosive removal of material and also a composition for reducing the corrosive removal of material in the anticorrosion treatment of metallic surfaces.

This object is achieved by a process according to claim 1, a composition according to claim 20, a concentrate according to claim 21 and a use according to claim 22. Advantageous embodiments are in each case described in the dependent claims.

In the process of the invention for the anticorrosion treatment of a metallic surface, the surface is brought into contact in succession with the following aqueous compositions:
i) an alkaline or acidic cleaner composition,
ii) a first rinsing composition,
iii) optionally a second rinsing composition,
iv) an acidic conversion composition,
v) optionally a third rinsing composition and
vi) a composition comprising a (meth)acrylate- and/or epoxide-based CEC,

where at least one of the compositions i) to v) comprises at least one compound of the formula I

R¹O—(CH₂)ₓ—Z—(CH₂)_{y}—OR² (I)

and R¹ and R² are each, independently of one another, H or an HO—(CH₂)_{w}— group with w≥2, x and y are each, independently of one another, from 1 to 4 and Z is an S atom or a C—C triple bond.

### Definitions

For the present purposes, an “aqueous composition” is a composition which comprises predominantly, i.e. to an extent of more than 50% by weight, water as solvent/dispersion medium. The aqueous composition is preferably a solution, more preferably a solution which comprises only water as solvent.

The fact that the metallic surface is brought into contact in succession with the aqueous compositions i) to vi) does not rule out it being brought into contact with one or more further compositions before and/or after this sequence. Furthermore, the metallic surface additionally being brought into contact with one or more further compositions between contacting with the various compositions i) to vi) is not ruled out.

The at least one compound of the formula I acts as physical corrosion inhibitor which is adsorbed by means of van der Waals forces on the metallic surface, as a result of which a monomolecular, homogeneous, densely packed layer is formed on the surface. The metallic surface is physically shielded by said layer against attack by protons or hydroxide ions and the corrosive removal of material from the surface is thus prevented or at least reduced.

In a first preferred embodiment, the cleaner composition i) comprises at least one compound of the formula I.

In this case, the concentration of the at least one compound of the formula I in the cleaner composition i) is preferably in the range from 6 to 625 mg/l, particularly preferably in the range from 31 to 313 mg/l (calculated as 2-butyne-1,4-diol).

In a second preferred embodiment, the first rinsing composition ii), the second rinsing composition iii) and/or the third rinsing composition v) comprises at least one compound of the formula I.

The use of the at least one compound of the formula I in one or more of the rinsing compositions has the advantage of reducing the formation of a rust film on steel and/or galvanized steel.

Here, the concentration of the at least one compound of the formula I in the first rinsing composition ii), in the second rinsing composition iii) and in the third rinsing composition v) is preferably in the range from 1 to 100 mg/l, particularly preferably in the range from 6 to 60 mg/l (calculated as 2-butyne-1,4-diol).

In a third preferred embodiment, the conversion composition iv) comprises at least one compound of the formula I.

Here, the concentration of the at least one compound of the formula I in the conversion composition iv) is in the range from 1 to 100 mg/l, preferably in the range from 3 to 100 mg/l and particularly preferably in the range from 30 to 100 mg/l (calculated as 2-butyne-1,4-diol).

The metallic surface is optionally additionally brought into contact with an aqueous pickling composition vii) and subsequently with a fourth rinsing composition viii) between the contacting with the first rinsing composition ii) or optionally the second rinsing composition iii) and the conversion composition iv). However, it is likewise possible to bring the metallic surface into contact with an aqueous pickling composition vii) and subsequently a fourth rinsing composition viii) before contacting with the cleaner composition i).

The pickling composition vii) preferably comprises at least one compound selected from the group consisting of phosphonates, condensed phosphates and citrate and/or at least one mineral acid selected from the group consisting of sulfuric acid, hydrochloric acid, hydrofluoric acid and nitric acid; it particularly preferably comprises at least one mineral acid selected from the group consisting of sulfuric acid, hydrochloric acid, hydrofluoric acid and nitric acid and very particularly preferably comprises sulfuric acid.

In a further embodiment, the pickling composition vii) comprises at least one compound of the formula I.

In this case, the concentration of the at least one compound of the formula I in the pickling composition vii) is in the range from 31 to 620 mg/l, preferably in the range from 31 to 310 mg/l (calculated as 2-butyne-1,4-diol).

The use of the at least one compound of the formula I in the pickling composition has the advantage of reducing the corrosive removal of material particularly effectively.

The cleaner composition i) is preferably alkaline and more preferably has a pH of 9.5 or more.

The first rinsing composition ii), the second rinsing composition iii) and the third rinsing composition v) preferably have a pH in the range from 2 to 10, more preferably in the range from 3 to 10.

The first rinsing composition is preferably weakly acidic, weakly alkaline or neutral. It particularly preferably has a pH in the range from 6 to 9.

The second rinsing composition is preferably weakly alkaline or neutral. It particularly preferably has a pH in the range from 7 to 9.

The third rinsing composition preferably has a pH in the range from 4 to 9; it is particularly preferably weakly acidic, weakly alkaline or neutral. It very particularly preferably has a pH in the range from 6 to 8.

The conversion composition iv) is preferably a passivating composition comprising a titanium, zirconium and/or hafnium compound.

The passivating composition iv) is preferably substantially manganese-free. “Substantially manganese-free” here means that the passivating composition comprises less than 10 mg/l of manganese.

The titanium, zirconium and/or hafnium compound is preferably the corresponding hexafluoro complex, very particularly preferably hexafluorozirconate.

The passivating composition iv) preferably comprises copper ions and/or a compound which liberates copper ions, and/or comprises zinc ions and/or a compound which liberates zinc ions.

Furthermore, the passivating composition iv) preferably comprises an organoalkoxysilane and/or a hydrolysis and/or condensation product thereof.

The organoalkoxysilane preferably has at least one amino group. It is particularly preferably an organoalkoxysilane of this type which can be hydrolyzed to an aminopropylsilanol and/or to 2-aminoethyl-3-aminopropylsilanol and/or is a bis(trimethoxysilylpropyl)amine.

The passivating composition can also comprise a polymer and/or copolymer.

In a preferred embodiment, the at least one compound of the formula I is a mixture of a compound of the formula I in which R¹ and R² are both H and a compound of the formula I in which R¹ and R² are each, independently of one another, an HO—(CH₂)_{w}— group with w 2.

Here, the mixing ratio in % by weight of the compound of the formula I in which R¹ and R² are both H and the compound of the formula I in which R¹ and R² are each, independently of one another, an HO—(CH₂)_{w}— group with w 2 is in the range from 0.5:1 to 2:1, preferably in the range from 0.75:1 to 1.75:1 and particularly preferably in the range from 1:1 to 1.5:1 (calculated as 2-butyne-1,4-diol and 2-butyne-1,4-diol bis(2-hydroxyethyl) ether).

In the at least one compound of the formula I, R¹ and R² are preferably both H or an HO—(CH₂)₂— group, the sum of x and y is from 2 to 5 and Z is a C—C triple bond.

Further preference is given to the at least one compound of the formula I being 2-butyne-1,4-diol and/or 2-butyne-1,4-diol bis(2-hydroxyethyl) ether.

The at least one compound of the formula I is particularly preferably a mixture of 2-butyne-1,4-diol and 2-butyne-1,4-diol bis(2-hydroxyethyl) ether, with the mixing ratio in % by weight being in the range from 0.5:1 to 2:1, preferably in the range from 0.75:1 to 1.75:1 and particularly preferably in the range from 1:1 to 1.5:1.

The metallic surface treated by the process of the invention is preferably the surface of a metal strip or a metallic component, for example the bodywork of a vehicle.

The metallic surface can comprise bare steel, electrolytically galvanized steel and/or hot galvanized steel, aluminum and/or an aluminum alloy.

In a preferred embodiment, the metallic surface also comprises aluminum or an aluminum alloy in addition to bare steel and/or galvanized steel (known as multimetal capability).

In the case of an acrylate- and/or epoxide-based CEC (cathodic electrophoretic coating), the process of the invention has been found to be advantageous in respect of improved adhesion of the coating and also improved corrosion protection.

A topcoat is optionally then additionally applied to the cathodically electrophoretically coated metallic surface.

The present invention additionally provides an aqueous composition for reducing the corrosive removal of material in the anticorrosion treatment of metallic surfaces, which composition comprises at least one compound of the formula I as described above.

In addition, the invention provides a concentrate from which the aqueous composition of the invention is obtainable by dilution with a suitable solvent and/or dispersion medium, preferably with water, and optionally adjustment of the pH.

The dilution factor is preferably in the range from 1:10 to 1:10 000, particularly preferably in the range from 1:50 to 1:200.

Finally, the present invention also provides for the use of the metallic surface which has been treated by the process of the invention.

The present invention is illustrated by the following nonlimiting examples.

### EXAMPLES

i) Determination of the Corrosion Current Density:

Measurement Principle:

To assess the reduction in the corrosive removal of material on bare and galvanized steel, the DC method was employed and specifically the current density-potential was measured.

Here, the system is pushed from the equilibrium state by application of an external potential.

When the corrosion process is considered, an anodic subcurrent and a cathodic subcurrent are obtained as a result of the anodic and cathodic reactions which proceed. A negative current is obtained for the reduction process and a positive current is obtained for the oxidation process at the metallic surface.

The cathodic subcurrent represents the cathodic reaction. At pH values of 4 or above, the reduction of oxygen is dominant. The anodic subcurrent equates to the anodic reaction or the oxidation of the metal. Subcurrent density-potential curves can be derived therefrom:

$$Cathodic Subcurrent \text{:} i = - {i}_{0} * exp ( \frac{- ( 1 - α ) n F}{RT} * ( E - {E}_{\frac{1}{z}} ) )$$

$$Anodic Subcurrent \text{:} i = {i}_{0} * exp ( \frac{α n F}{RT} * ( E - {E}_{\frac{1}{z}} ) )$$

Owing to the electrical neutrality criterion, anodic and cathodic subcurrents are of equal magnitude at a particular potential. This point is the rest potential. From the above equations for the cathodic and anodic subcurrents, it is ultimately possible to determine the corrosion potential E_{corr} and the corrosion current density I_{corr}, from which it is possible to draw conclusions regarding the corrosion behavior of the sample. E_{corr} describes the rest potential. I_{corr} corresponds to the cathodic and anodic subcurrent densities which are of equal magnitude at the rest potential.

The respective subcurrents are plotted as Tafel straight lines. Here, the logarithm of the currents is plotted against the potential, forming straight lines. The corrosion potential E_{corr} and the corrosion current density I_{corr} can be read off from the intersection of the logarithms of the subcurrents. The evaluation is carried out in the linear part of the curve.

The smaller the corrosion current density I_{corr} the smaller the tendency for rust formation and the greater the inhibition and thus the reduction in corrosive attack on the workpiece.

Experimental Setup:

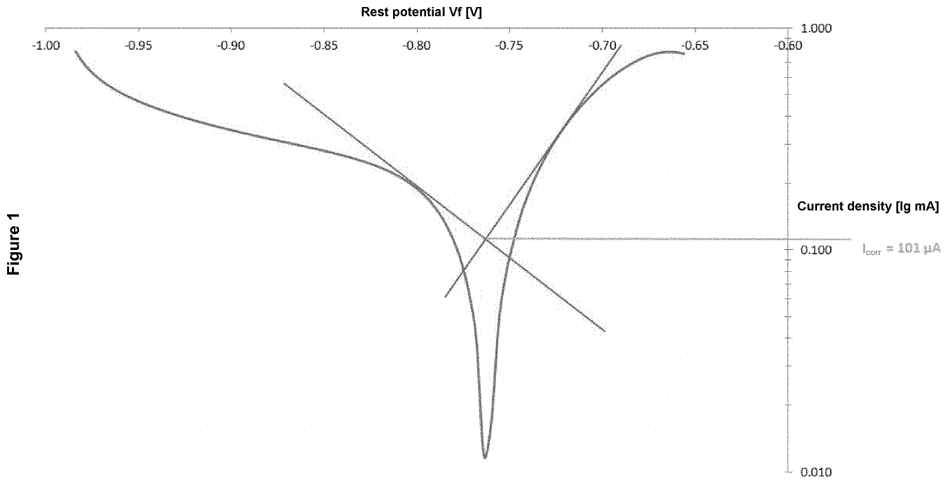

With the aid of the current density-potential curve as TAFEL presentation (cf. FIG. 1), various aqueous solutions A to E were compared:

A: Highly corrosive, alkaline multimetal cleaner

B: Highly corrosive, alkaline multimetal cleaner comprising 3.35 g/l of borate (calculated as B₂O₃)

C: Highly corrosive, alkaline multimetal cleaner comprising 62.5 mg/l of but-2-yne-1,4-diol and 50 mg/l of 2-butyne-1,4-diol bis(2-hydroxyethyl) ether

D: Deionized water

E: Deionized water comprising 62.5 mg/l of but-2-yne-1,4-diol and 50 mg/l of 2-butyne-1,4-diol bis(2-hydroxyethyl) ether

The corrosion potential changes with time. In the context of the present invention, the metal to be protected is permanently exposed to the electrolyte over a prolonged period of time. The measurements were therefore always carried out immediately (I_{corr} immediate) and after one hour (I_{corr} after 1 h).

All measurements were carried out both on bare steel and on hot-galvanized steel. By way of example, the evaluation of the TAFEL presentation is shown for solution A on bare steel (CRS) in FIG. 1. The values determined in this way are shown in tab. 1.

TABLE 1

| Solution | Substrate | I_{corr} immediate | | I_{corr} after 1 h | | ΔI_{corr} | |
|---|---|---|---|---|---|---|---|
| A | Steel | 101 | μA | 90 | μA | 11 | μA |
| A | Galvanized steel | 110 | μA | 102 | μA | 8 | μA |
| B | Galvanized steel | 108 | μA | 102 | μA | 6 | μA |
| C | Steel | 95 | μA | 75 | μA | 20 | μA |
| C | Galvanized steel | 105 | μA | 102 | μA | 3 | μA |
| D | Galvanized steel | 2 | μA | 11 | μA | 9 | μA |
| E | Galvanized steel | 5 | μA | 3 | μA | 2 | μA |

Evaluation:

The measured values for the solutions A to C and secondly the measured values for the solutions D and E were compared. In terms of the anticorrosion properties, not only the absolute corrosion current densities I_{corr} but especially the difference between the immediate measurement and the measurement after one hour (ΔI_{corr}) were critical.

Particularly in the case of galvanized material, it can be seen here that compared to the prior art (solutions A and B), both the absolute corrosion current density I_{corr} and also the difference ΔI_{corr} over a period of one hour are lower in the case of the solution C according to the invention.

This demonstrates the anticorrosion properties of the mixture of but-2-yne-1,4-diol and 2-butyne-1,4-diol bis(2-hydroxyethyl) ether used, both during the process and also during a downtime of the plant. In addition, said mixture has an effect not only in the strongly alkaline pH range, cf. solutions A to C, but also in a pH-neutral and salt-neutral medium, cf. solutions D and E. In the case of the latter, the significantly lower difference Δ is particularly noteworthy.

i) Determination of the Corrosive Removal of Material:

Measurement Principle:

The corrosive removal of material indicates the percentage by which the weight loss of the metal is reduced by addition of an inhibitor. A defined test plate is dipped into the corresponding test solution. The loss in mass on the surface is determined gravimetrically both before and after.

Experimental Setup:

The test plates were firstly cleaned with petroleum spirit. The residual carbon content after cleaning was less than 10 mg/m². The mass of each cleaned 105×190 mm test plate made of hot-galvanized steel was determined on an analytical balance. Immediately after the determination of the mass, the test plates were each hung in a 3 liter glass beaker comprising an appropriate test solution. The solution was stirred by means of a 40 mm magnetic stirrer bar. The stirring speed at the bottom of the glass beaker was 400 rpm.

After 3 minutes, the test plates were in each case taken from the solution, rinsed with distilled water and dried by means of compressed air. The mass of each test plate was subsequently determined again by means of the analytical balance.

The aqueous solutions A, B of the prior art as described above (under “Determination of the corrosion current density”, “Experimental setup”) and the solution C according to the invention were tested in parallel with and without corrosion inhibitor.

Evaluation:

The difference between the two masses determined is calculated for each test plate. From the weight loss (corrosive removal of material) of hot-galvanized test plates in solution which has not been inhibited (Mn; solution A) and inhibited solution (Mi; solution B or C), it is possible to calculate the inhibiting effect of a corrosion inhibitor by calculation according to the following formula:

$$Inhibition index = \frac{Mn - Mi}{Mn} \times 100$$

The results are summarized in tab. 2.

TABLE 2

| | | Weight | Corrosive removal | Inhibition |
|---|---|---|---|---|
| Solution | Substrate | loss | of material | index |
| A | Galvanized steel | 0.0075 g | 0.1875 g/m² | — |
| B | Galvanized steel | 0.0046 g | 0.1150 g/m² | 38.67% |
| C | Galvanized steel | 0.0028 g | 0.0700 g/m² | 62.67% |

The inhibition index indicates the percentage by which the attack on the workpiece can be reduced by the inhibitor(s). The higher this inhibition index compared to the solution A which has not been inhibited, the greater the anticorrosion properties within the pretreatment process.

When the inhibition index for the alkaline cleaner B according to the prior art and the alkaline cleaner C according to the invention are compared, it can clearly be seen that the mixture of but-2-yne-1,4-diol and 2-butyne-1,4-diol bis(2-hydroxyethyl) ether used has a significantly higher inhibition index.

iii) Conclusion:

Both the demonstrated significantly lower corrosion current density and also the significantly higher inhibition index determined confirm the anticorrosion properties and also the reduction in loss of material by addition of compounds of the formula I, here a mixture of but-2-yne-1,4-diol and 2-butyne-1,4-diol bis(2-hydroxyethyl) ether, in pH-neutral and alkaline media.

The reduction in the loss of material is necessary in order to remove very little of the galvanization within the process and thus reduce associated zinc phosphate sludge in the corresponding cleaner zones of a pretreatment plant.

In addition, a higher inhibition index and a low difference in the corrosion current density after one hour correlates with a better anticorrosion property, in particular during periods of severe conditions and plant downtimes. Rust film formation is prevented. In this way, compounds of the formula I now make it possible to continue to treat the relevant workpieces with a protective conversion layer even after plant downtimes.

iv) Determination of Adhesion of Coating and Corrosion Protection:

Test plates made of bare steel (CRS) were in each case sprayed in succession for 180 s and at 45° C. with a highly corrosive, alkaline multimetal cleaner, for 30 s with mains water (first rinsing composition) and for 20 s with deionized water (second rinsing composition). They were subsequently sprayed with a conversion composition (cf. tab. 3) for 120 s at 30° C. (conversion composition A′; see below) or 40° C. (conversion composition B′ and C′; see below) and then with deionized water (third rinsing composition) for 20 s. Finally, the test plates were dried by means of compressed air, coated with an acrylate-based CEC and subjected to lattice cutting tests, stone impact tests and NSS tests.

Different conversion compositions A′ to C′ were used. This gave 3 process variants. These are shown in detail in tab. 3 below.

TABLE 3

| Variant | Conversion comp. |
|---|---|
| 1 | A′ |
| 2 | B′ |
| 3 | C′ |

The conversion composition A′ is an acidic aqueous solution comprising 0.2 g/l of zirconium, 0.1 g/l of each of zinc and manganese, 0.3 g/l of total fluoride and 30 mg/l of free fluoride at pH 5.2.

The conversion composition B′, on the other hand, is an acidic aqueous solution comprising 0.1 g/l of zirconium, 0.4 g/l of zinc, 0.1 g/l of total fluoride, 2 mg/l of copper and 30 mg/l of free fluoride at pH 4.9, which additionally comprises 3.1 mg/l of but-2-yne-1,4-diol and 2.5 mg/l of 2-butyne-1,4-diol bis(2-hydroxyethyl) ether.

Finally, the conversion composition C′ is an acidic aqueous solution comprising 0.1 g/l of zirconium, 0.4 g/l of zinc, 0.1 g/l of total fluoride, 5 mg/l of copper and 30 mg/l of free fluoride at pH 4.9, which additionally comprises 31 mg/l of but-2-yne-1,4-diol and 25 mg/l of 2-butyne-1,4-diol bis(2-hydroxyethyl) ether.

In each case, a lattice cut test after 0 and 40 hours was carried out in accordance with BMW AA-0264 (test) and DIN EN ISO 2409 (method) and also a stone impact test in accordance with BMW AA-0264, BMW AA-079 (test) and DIN EN ISO 20567-1 (method) were carried out (to determine the adhesion of the coating). In addition, an NSS test under neutral conditions was carried out after 504 hours and after 1008 hours in accordance with DIN EN ISO 9227 NSS (test) and d-DIN EN ISO 4628-8 (method) (in order to determine the corrosion protection).

The values determined in this way are shown in tab. 4 below.

TABLE 4

| | |
|---|---|
| Lattice cut | NSS |

| Variant | 0 h | 40 h | Stone imp. | 504 h | 1008 h |
|---|---|---|---|---|---|
| 1 | 1 | 1 | 5 | 6.0 | 11.5 |
| 2 | 0 | 0 | 1 | 0.9 | 1.6 |
| 3 | 0 | 0 | 1 | 0.8 | 1.4 |

The excellent results of process variants 2 and 3 according to the invention can clearly be seen. The addition of a mixture of but-2-yne-1,4-diol and 2-butyne-1,4-diol bis(2-hydroxyethyl) ether to the conversion composition leads here, as can be seen from the comparison with process variant 1, to an outstanding improvement, especially in respect of stone impact, and also the NSS test (after 504 and 1008 hours).

A further improvement in the NSS test (after 504 and 1008 hours) resulting from increasing the concentration of said mixture can likewise be observed. This can be seen from a comparison of the process variant 3 with the process variant 2.

1. A process for anticorrosion treatment of a metallic surface, wherein the surface is brought into contact in succession with the following aqueous compositions:
i) an alkaline or acidic cleaner composition,
ii) a first rinsing composition,
iii) optionally a second rinsing composition,
iv) an acidic conversion composition,
v) optionally a third rinsing composition and
vi) a composition comprising a (meth)acrylate- and/or epoxide-based CEC,
where at least one of the compositions i) to v) comprises at least one compound of the formula I
R¹O—(CH₂)ₓ—Z—(CH₂)_{y}—OR² (I)
and R¹ and R² are each, independently of one another, H or an HO—(CH₂)_{w}— group with w 2, x and y are each, independently of one another, from 1 to 4 and Z is an S atom or a C—C triple bond.

2. The process according to claim 1, wherein the cleaner composition i) comprises at least one compound of the formula I.

3. The process according to claim 2, wherein the concentration of the at least one compound of the formula I is in the range from 6 to 625 mg/l (calculated as 2-butyne-1,4-diol).

4. The process according to claim 1, wherein the first rinsing composition ii), the second rinsing composition iii) and/or the third rinsing composition v) comprises at least one compound of the formula I.

5. The process according to claim 4, wherein the concentration of the at least one compound of the formula I is in the range from 1 to 100 mg/l (calculated as 2-butyne-1,4-diol).

6. The process according to claim 1, wherein the conversion composition iv) comprises at least one compound of the formula I.

7. The process according to claim 6, wherein the concentration of the at least one compound of the formula I is in the range from 1 to 100 mg/l (calculated as 2-butyne-1,4-diol).

8. The process according to claim 1, wherein the cleaner composition i) is alkaline.

9. The process according to claim 1, wherein the first rinsing composition ii) has a pH in the range from 6 to 9, the second rinsing composition iii) has a pH in the range from 7 to 9 and the third rinsing composition v) has a pH in the range from 4 to 9.

10. The process according to claim 1, wherein the conversion composition iv) is a passivating composition comprising a titanium, zirconium and/or hafnium compound.

11. The process according to claim 10, wherein the passivating composition iv) is substantially manganese-free.

12. The process according to claim 10, wherein the passivating composition iv) comprises copper ions and/or a compound which liberates copper ions, and/or comprises zinc ions and/or a compound which liberates zinc ions.

13. The process according to claim 10, wherein the passivating composition iv) comprises an organoalkoxysilane and/or a hydrolysis and/or condensation product thereof.

14. The process according to claim 1, wherein the at least one compound of the formula I is a mixture of a compound of the formula I in which R¹ and R² are both H and a compound of the formula I in which R¹ and R² are each, independently of one another, an HO—(CH₂)_{w}— group with w≥2.

15. The process according to claim 14, wherein a mixing ratio in % by weight of the compound of the formula I in which R¹ and R² are both H and the compound of the formula I in which R¹ and R² are each, independently of one another, an HO—(CH₂)_{w}— group with w 2 is in the range from 0.5:1 to 2:1 (calculated as 2-butyne-1,4-diol and 2-butyne-1,4-diol bis(2-hydroxyethyl) ether).

16. The process according to claim 1, wherein, in the at least one compound of the formula I, R¹ and R² are both H or an HO—(CH₂)₂— group, the sum of x and y is from 2 to 5 and Z is a C═C double bond.

17. The process according to claim 16, wherein the at least one compound of the formula I is 2-butyne-1,4-diol and/or 2-butyne-1,4-diol bis(2-hydroxyethyl) ether.

18. The process according to claim 17, wherein the at least one compound of the formula I is a mixture of 2-butyne-1,4-diol and 2-butyne-1,4-diol bis(2-hydroxyethyl) ether.

19. The process according to claim 1, wherein the metallic surface also comprises aluminum or an aluminum alloy in addition to bare steel and/or galvanized steel.

20. An aqueous composition for reducing corrosive removal of material in anticorrosion treatment of metallic surfaces, wherein the aqueous composition comprises at least one compound of the formula I according to claim 1.

21. A concentrate from which a composition according to claim 20 is obtainable by dilution with a suitable solvent and/or dispersion medium and optionally adjustment of the pH.

22. The use of the metallic surface which has been treated by a process according to claim 1.
